(19) United States
(12) Patent Application Publication
(10) Pub. No.: US 2026/0302821 A1
(43) Pub. Date: Oct. 1, 2026

(54) DC BUS POWER SLEW RATE CONTROL USING ENERGY STORAGE DEVICE

(71) Applicant: AMD Design, LLC, Wilmington, DE (US)

(72) Inventor: Brian GRIFFITH, Bonnery Lake, WA (US)

(73) Assignee: AMD Design, LLC, Wilmington, DE (US)

(21) Appl. No.: 19/095,552

(22) Filed: Mar. 31, 2025

(51) Int. Cl. H02J 7/00; H02M 3/158

(52) U.S. Cl. CPC H02J 7/933; H02J 7/52; H02J 7/82; H02J 7/855; H02M 3/1582; H02J 2105/425

(57) ABSTRACT

A system including at least a server, a bus bar, a power shelf and a power regulator. The power shelf can be configured to provide a direct current (DC) power to the server via the bus bar. The power regulator can be configured to receive a load signal from the power shelf, where the load signal can represent a load status of the power shelf. The power regulator can be further configured to, based on the load signal, regulate power between a battery and the bus bar to control a slew rate of the DC power on the bus bar, where the battery can be a part of the power regulator.

### FIELD

The present disclosure relates in general to controlling slew rates of direct current (DC) power being provided to a load, particularly, DC power from a power shelf to a server.

### BACKGROUND

A data center can house a large number of servers, storage systems, and networking equipment. The data center can provide infrastructure such as power, cooling and security necessary to ensure that the servers operate efficiently and reliably. The servers in the data center can have various types of workloads such as data processing, storage, and networking tasks. In an aspect, one example workload that can be handled by the servers can include artificial intelligence (AI) applications that may include machine learning model training using relatively large datasets as training data. In order to process the large datasets efficiently, the servers can use high performance components configured to handle relatively intensive computational requirements of AI applications, such as high-performance graphics processing units (GPUs), tensor processing units (TPUs), high-performance central processing units (CPUs), field-programmable gate arrays (FPGAs), various storage systems and networking components capable of handling the large datasets.

To support the servers performing tasks relating to AI applications, the data center needs to provide sufficient infrastructure such as sufficient power, storage, networking equipment, etc. In an aspect, local computers or servers may not be configured to handle the intense computations required for AI applications. Hence, users can purchase cloud computing services that provide computing resources for handling the intense computations. Cloud based data centers are data centers distributed in a cloud computing network and can be located in different geographical locations. In some aspects, infrastructure provided by cloud based data centers can be installed with uninterruptible power supply (UPS) and various types of generator systems to ensure uninterrupted services and availability.

### SUMMARY

A device is described herein. The device includes a battery, a voltage regulator and a controller. The controller can be configured to receive a load signal from a power shelf, wherein the load signal represents a load status of the power shelf. The controller can be further configured to, based on the load signal, control the voltage regulator to regulate power between the battery and a bus bar connecting a server to the power shelf. The power regulation between the battery and the bus bar can control a slew rate of a direct current (DC) power being outputted from the power shelf on the bus bar.

A system is also described herein. The system includes a server, a bus bar, a power shelf and a power regulator. The power shelf can be configured to provide a direct current (DC) power to the server via the bus bar. The power regulator can be configured to receive a load signal from the power shelf, where the load signal can represent a load status of the power shelf. The power regulator can be further configured to, based on the load signal, regulate power between a battery and the bus bar to control a slew rate of the DC power provided by the power shelf on the bus bar.

A method regulating power between a power shelf and a server is also described herein. The method includes receiving a load signal from the power shelf, where the load signal can represent a load status of the power shelf. The method can also include, based on the load signal, regulating power between a battery and a bus bar to control a slew rate of a direct current (DC) power being outputted by the power shelf on the bus bar, wherein the bus bar connects the server to the power shelf.

The foregoing summary is illustrative only and is not intended to be in any way limiting. In addition to the illustrative aspects, embodiments, and features described above, further aspects, embodiments, and features will become apparent by reference to the drawings and the following detailed description. In the drawings, like reference numbers indicate identical or functionally similar elements.

### BRIEF DESCRIPTION OF THE DRAWINGS

FIG. 1A illustrates a system including a power shelf and a server.

FIG. 1B illustrates waveforms representing server load demand and DC power provided by a power shelf that can be compensated by DC bus power slew rate control using energy storage device.

FIG. 2 illustrates an example system that can implement power slew rate control using energy storage device in accordance with this disclosure.

FIG. 3 illustrates an example implementation of power slew rate control using energy storage device in accordance with this disclosure.

FIG. 4 illustrates another example implementation of power slew rate control using energy storage device in accordance with this disclosure.

FIG. 5 illustrates an example circuit that can implement power slew rate control using energy storage device in accordance with this disclosure.

FIG. 6 illustrates waveforms representing various power signals resulting from an implementation of power slew rate control using energy storage device in accordance with this disclosure.

FIG. 7 illustrates an example method of power slew rate control using energy storage device in accordance with this disclosure.

### DETAILED DESCRIPTION

### Overview

The intense computation of AI application tasks can occupy a relatively large percentage of the server's workload and may be incompatible with the existing infrastructure of a cloud based data center. For example, the large AI training workloads can create large load transients with high slew rates, such as slew rates that cannot be handled by the DC power provided by the power shelf in the cloud based data center infrastructure. The high slew rates can result from, for example, synchronization of a large number of GPUs working together during machine learning model training or for other reasons.

In some examples, power shelfs in the infrastructure of cloud based data centers can include any suitable number of uninterruptible power supply (UPS) units that that power equipment in the event of grid power failure. However, the UPS in the infrastructure also cannot handle the high slew rates resulting from certain AI application tasks. High dynamic load from AI applications that exceeds approximately 40% of the UPS's rating can result in AC voltage foldback and may cause under voltage conditions that lead to the server rack shutting down. For data centers that are not cloud based, supercomputers that can handle intense computations can be installed and supported with local utilities to prevent shut down. However, for cloud based data centers, the UPS and other types of generator systems may be needed to ensure uninterrupted services and availability. Therefore, to avoid under voltage conditions that may shut down server racks in a cloud based data center using UPS, the number of server racks with computing resources capable of handling AI applications can be limited in the cloud based data center.

The power regulation described herein can provide an in-rack regenerative load technique to buffer and/or compensate the DC power provided by power shelfs to servers that demand intensive computations. The power received by servers can be shaped and/or formed by combining the power from energy storage devices, such as batteries, with the DC power. The power received by the servers can then be maintained within the operating envelopes of a power shelf that may include UPS and various types of generators. The shaping of the server power described herein can suitably match the slew rate of the server power to the slew rate of the server load, reduce overshoot, and maintain a desired duty cycle such as 50%, which in at least some cases may be considered optimal. Also, the power regulation described herein can be added to various types of existing server racks without modifications to the server racks themselves, and can be operate in parallel with various types of AC/DC power supplies.

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

### Example System

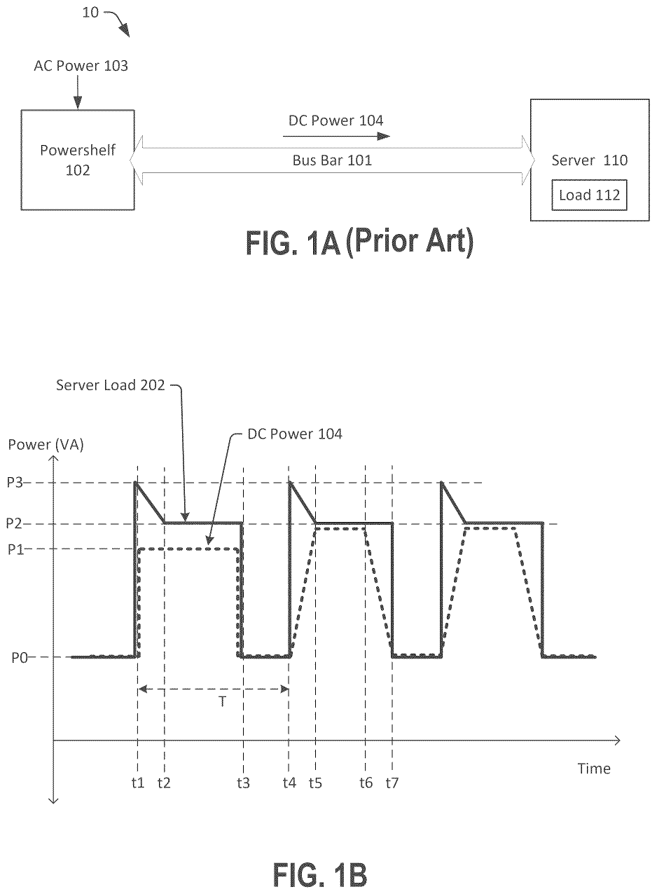

FIG. 1A illustrates a system 10 including a power shelf 102 and a server 110. System 10 can be implemented in a server rack. Server 110 may not include any internal power supply.

Hence, server 110 can be positioned in a server rack that provides power shelf 102 and a bus bar 101 for transmitting DC power from power shelf 102 to one or more servers, such as server 110. Power shelf 102 can include one or more power supply units that can be connected to one or more external power supplies. Power shelf 102 can receive alternating current (AC) power 103 from any useful source such as a grid, a transformer, or an uninterruptible power supply (UPS), for example, and convert AC power 103 into direct current (DC) power 104. Power shelf 102 can be configured to supply DC power 104 to server 110 via any power connection element(s) such as bus bar 101 or wires.

The loads in server 110 can demand different amounts of DC power for operation. Also, different types of tasks being assigned to server 110 can use computing resources that demand different loads. For example, if load 112 is a memory device, a relatively simple task of reading and writing data to the memory device can demand a relatively small amount of power. For AI applications, such as machine learning model training, the intense computations involved can utilize more computing resources and a higher amount of power may be demanded. Further, when a specific load has a high power demand, or when more than one loads are performing various tasks in parallel or otherwise concurrently, the server load (e.g., combination of workload of all loads in server 110) and the power demand of server 110 can increase at a relatively high slew rate. In an aspect, the slew rate can be a rate of change of the power, including increasing rate and decreasing rate, being transferred between power shelf 102 and server 110. The higher demand from server 110 can also increase the amount of power being drawn from power shelf 102 towards server 110.

Referring to FIG. 1B, a waveform of the server load of server 110 labeled as server load 202, and a waveform of DC power 104, are shown. The waveform labeled as server load 202 can represent a combination of workload of all loads (e.g., including load 112) in server 110. In the example shown in FIG. 1B, server load 202 of server 110 can be drawing power P0 initially, such as prior to time t1. At time t1, server load 202 of server 110 increases and more power is demanded by server 110. In the example shown in FIG. 1B, at time t1, server load 202 increases at a relatively high slew rate from initial power P0 and overshoot to a power P3. The overshoot at time t1 can be caused by various factors, such as capacitive effects, inductor effects, parasitic elements, and/or other factors. At time t2, server load 202 has been reduced to the desired power P2. At time t1, if the slew rate of DC power 104 matches with server load 202, the maximum of DC power is P1, which is less than the desired power P2. Therefore, power shelf 102 cannot support the maximum slew rate of server load 202 because a source of the AC power 103 (e.g., a UPS) cannot slew power fast enough to support the input voltage to the power shelf 102.

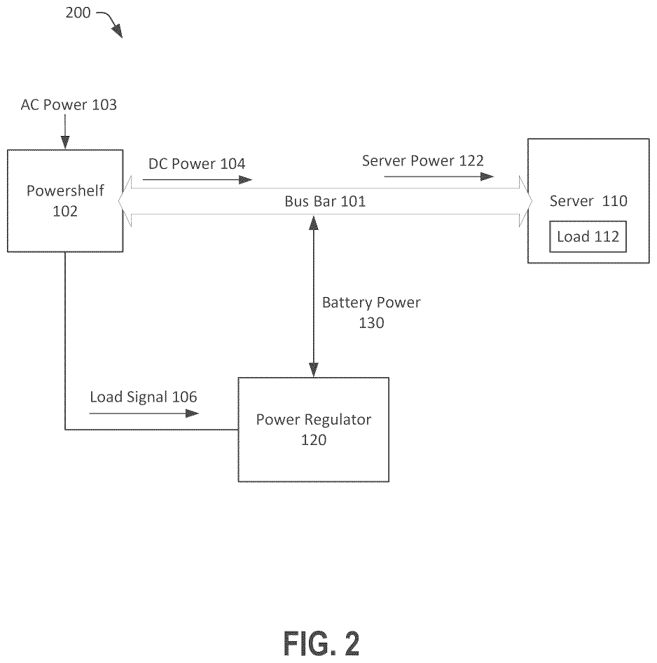

FIG. 2 illustrates an example system 200 that can implement a power slew rate control with energy storage device interfaced to system DC bus in accordance with this disclosure. In one embodiment, system 200 can be implemented in a server rack. System 200 can include power shelf 102, at least one server such as server 110 shown in FIG. 1A, and a power regulator 120. Server 110 may not include any internal power supply and the server rack that provides power shelf 102 and bus bar 101 can facilitate a supply of power to server 110. Bus bar 101 can be, for example, a 50 volt (V) server rack bus bar for transmitting DC power from power shelf 102 to one or more servers, such as server 110. Server 110 can be, for example, a server including one or more loads, such as a load 112, that require different amounts of power to operate. The one or more loads in server 110 can include one or more of GPUs, TPUs, high-performance CPUs, FPGAs, storage systems, or networking equipment, and various other types of computing resources.

To address issues such as the power overshoot, mismatches of slew rates shown in FIG. 1B, power regulator 120 can be provided to system 10 shown in FIG. 1A, forming system 200 in FIG. 2, to compensate and regulate DC power 104. Power regulator 120 can be an energy storage device that can provide power regulation between bus bar 101 and an energy storage component, such as a battery, in power regulator 120. The power regulation can include adding a battery power 130 to DC power 104 being transferred on bus bar 101, or taking battery power 130 from DC power 104 being transferred on bus bar 101. Battery power 130 can be added to, or subtracted from, DC power 104 to generate server power 122 being supplied to server 110. Battery power 130, when combined with DC power 104, can form server power 122 that has reduced (or eliminated) power overshoot, slew rate that matches with server load of server 110.

In one embodiment, power shelf 102 can send a load signal 106 to power regulator 120. Load signal 106 can be a signal representing a load status of power shelf 102, where the load status can be a current condition of power shelf 102, such as the amount of electrical power (e.g., DC power 104) being drawn from power shelf 102. Load signal 106 can vary proportionally with the load status of power shelf 102 or DC power 104. In one embodiment, load signal 106 may not be a separate signal and may instead be represented by changes of the output voltage of power shelf 102 versus the load 112. Power regulator 120 can receive load signal 106. Power regulator 120 can be configured to monitor changes in load signal 106. Based on the changes in load signal 106, power regulator 120 can determine whether DC power 104 is increasing or decreasing at an unacceptable slew rate, such as being outside of a predetermined range of slew rates. When DC power 104 is changing at an acceptable rate, such as being within the predetermined range of slew rates, power regulator 120 may not regulate DC power 104 such that DC power 104 can be supplied to server 110 as server power 122. When DC power 104 is changing at an unacceptable rate, such as being outside of the predetermined range of slew rates, power regulator 120 can regulate DC power 104 between bus bar 101 and power regulator 120 to adjust the slew rate of DC power 104. The adjustment of the slew rate of DC power 104 can transform or shape DC power 104 into server power 122 that matches with the server load of server 110. In some aspects, changes in DC power 104 reflect changes in the server load of server 110. In one embodiment, the power regulation performed by power regulator 120 can include adding a battery power 130 to DC power 104, or reducing DC power 104 by battery power 130. In one embodiment, power regulator 120 can add battery power 130 to DC power 104 when DC power 104 steps up (e.g., low to high transition) and power regulator 120 can reduce DC power 104 by battery power 130 when DC power 104 steps down (e.g., high to low transition). In one embodiment, to add battery power 130 to DC power 104, power regulator 120 can discharge an energy storage device, such as a battery, to bus bar 101 to add battery power 130 to DC power 104. The addition of battery power 130 to DC power 104 can adjust a step-up slew rate of DC power 104. In one embodiment, to reduce DC power 104 by battery power 130, power regulator 120 can charge the energy storage device, such as the battery, using power from bus bar 101, such as a portion of DC power 104. The subtraction of battery power 130 from DC power 104 can adjust a step-down slew rate of DC power 104.

### Example Power Regulators

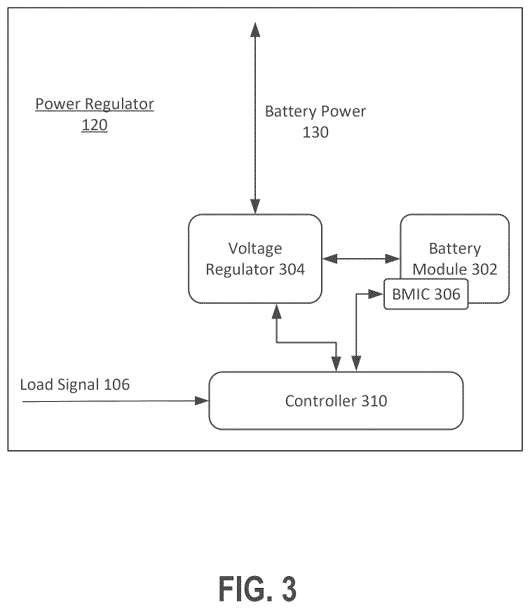

FIG. 3 illustrates an example power regulator 120 implementation having a power slew rate control with energy storage device interfaced to system DC bus in accordance with this disclosure. Descriptions of FIG. 3 may reference components shown in FIG. 1 and FIG. 2. In an example embodiment shown in FIG. 3, power regulator 120 can include at least a battery module 302, a voltage regulator 304, a battery management integrated circuit (BMIC) 306, and a controller 310. Voltage regulator 304 can be, for example, a DC-DC converter that can perform bi-directional voltage conversion. Voltage regulator 304 can also be a bi-directional buck-boost DC-DC converter that can be configured to step down or step up voltages.

Battery module 302 can be a battery pack including one or more batteries. Batteries in battery module 302 can be, for example, nickel-zinc (NiZn) batteries, sodium-ion (Na-ion) batteries, lithium-ion (Li-ion) batteries, or other suitable types of energy storage device. BMIC 306 can be configured to monitor and manage various aspects of battery module 302. By way of example, BMIC 306 can be configured to monitor the voltage, current, or voltage and current being provided to and from battery module 302, monitor the temperature of battery module 302, perform cell balancing if battery module 302 includes more than one battery cell, estimate remaining charge in the batteries of battery module 302, maintain the state of charge of battery module 302 at a target capacity, and manage various other aspects of battery module 302.

Controller 310 can be, for example, a microcontroller. Controller 310 can include various electronic components, such as processors, logic circuits, digital-to-analog converters (DACs), analog-to-digital converters (ADCs), comparators, mixers, filters, and various other types of electronic components. Controller 310 can also include memory devices, such as registers, configured to store various predefined reference and threshold values that may be needed for operating power regulator 120. Controller 310 can be configured to generate control signals for controlling voltage regulator 304.

Controller 310 can be configured to control voltage regulator 304 to perform voltage conversion in a forward direction (e.g., from bus bar 101 to battery module 302) and in a reverse direction (e.g., from battery module 302 to bus bar 101). In one embodiment, controller 310 can generate a discharge control signal to discharge battery module 302 such that charge can be discharged from battery module 302 to bus bar 101 in the reverse direction. The voltage conversion in the reverse direction can discharge battery module 302 to provide battery power 130 to bus bar 101, such that battery power 130 is added to DC power 104 to form server power 122. Further, controller 310 can generate a charge control signal to charge battery module 302 using power from bus bar 101 such that charge can be provided to battery module 302 in the forward direction. The voltage conversion in the forward direction can charge battery module 302 using power from bus bar 101, such that battery power 130 is subtracted from DC power to form server power 122. The addition and subtraction of battery power 130 can be performed at different times of a cycle of DC power 104, such as during step-up transition or step-down transition, to shape DC power 104 into server power 122 that has slew rates matching the slew rates of the server load of server 110.

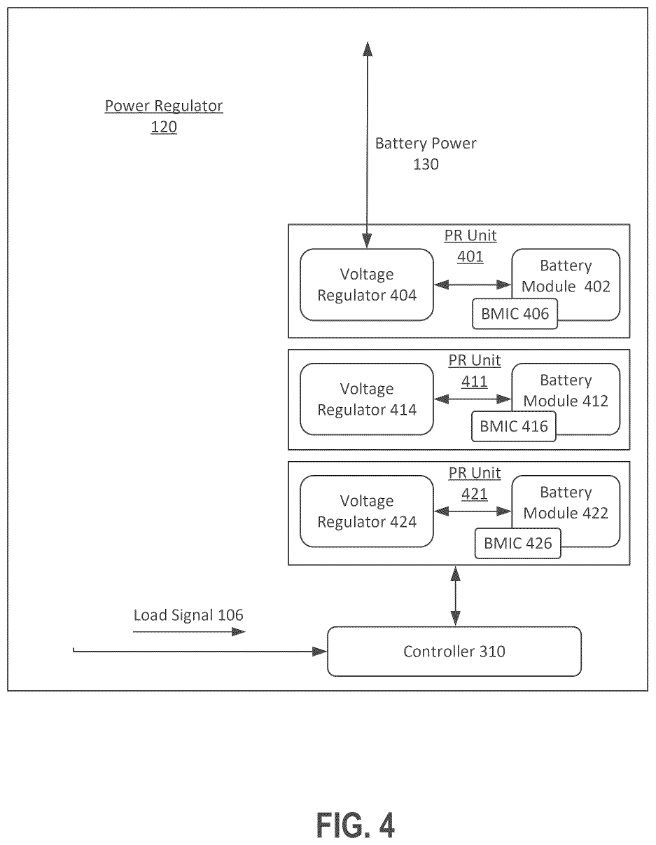

FIG. 4 illustrates another example power regulator 120 implementation of a power slew rate control with energy storage device interfaced to system DC bus in accordance with this disclosure. Descriptions of FIG. 4 may reference components shown in FIG. 1 to FIG. 3. In an example embodiment shown in FIG. 4, power regulator 120 can include a plurality of power regulator (PR) units, such as PR units 401, 411, 421 shown in FIG. 4. Each one of the plurality of PR units in power regulator 120 can include its respective battery, voltage regulator and BMIC. Each of PR units 401, 411, 421 can be identical or different. Controller 310 can be configured to control the plurality of PR units. PR unit 401 can include at least a battery module 402, a voltage regulator 404 and a BMIC 406. PR unit 411 can include at least a battery module 412, a voltage regulator 414 and a BMIC 416. PR unit 421 can include at least a battery module 422, a voltage regulator 424 and a BMIC 426. Voltage regulators 404, 414, 424 can be the same as voltage regulator 304 shown in FIG. 3 or different, and can be bi-directional buck-boost DC-DC converters or power supplies having a different architecture, and voltage regulators 404, 414, 424 can be configured to step down or step up voltages in the reverse direction to direct charge from power regulator 120 to bus bar 101, and in the forward direction to direct charge from bus bar 101 to power regulator 120.

Battery modules 402, 412, 422 can be the same as battery module 302 or different, and can be battery packs including one or more batteries. Batteries in battery modules 402, 412, 422 can be, for example, nickel-zinc (NiZn) batteries, sodium-ion (Na-ion) batteries, lithium-ion (Li-ion) batteries, or other suitable types of batteries. When power regulator 120 includes two or more PR units as shown in FIG. 4, each set of batteries in the individual PR units can provide same or different amounts of battery power. Having the plurality of PR units can provide a fail safe for system 200 in cases where one of the batteries is fully discharged. Further, having the plurality of PR units can allow controller 310 to select different amounts of battery power 130 among a discrete set of battery powers to be added to or subtracted from DC power 104.

BMICs 406, 416, 426 can be configured to monitor the voltage, current, or voltage and current being provided to and from their respective battery modules, monitor the temperature of their respective battery modules, perform cell balancing if their respective battery modules include more than one battery cell, estimate remaining charge in the batteries of their respective battery modules, maintain state of charge at a target capacity, and manage various other aspects of their respective battery modules.

### Example Circuit

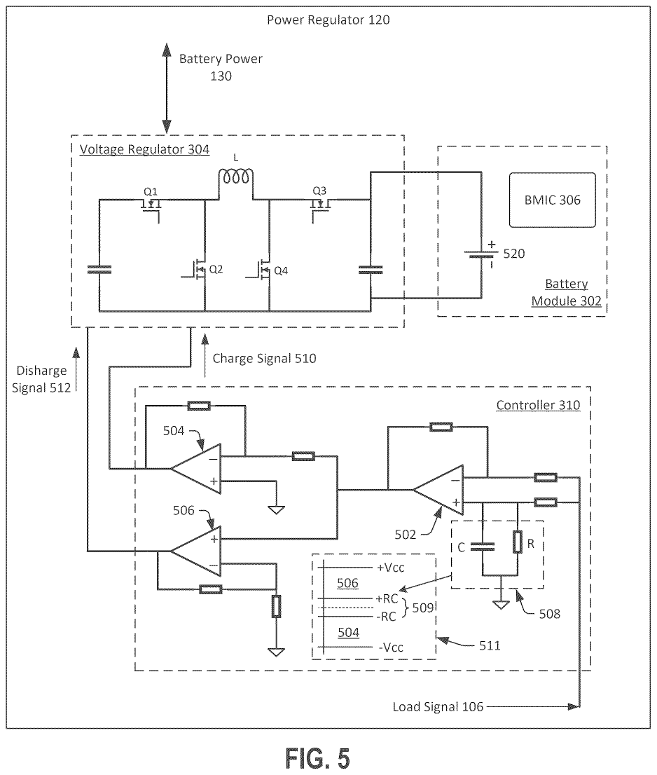

FIG. 5 illustrates an example power regulator 120 circuit that can implement a power slew rate control with energy storage device interfaced to system DC bus in accordance with this disclosure. Descriptions of FIG. 5 may reference components shown in FIG. 1 to FIG. 4.

Example implementations of battery module 302, voltage regulator 304 and controller 310, using various electronic circuit components, are shown in FIG. 5. The implementation of battery module 302 and voltage regulator 304 can also be applicable to the battery modules 402, 412, 422 and voltage regulators 404, 414, 424 shown in FIG. 4. In an example embodiment shown in FIG. 5, battery module 302 can include battery 520 and BMIC 306. In one embodiment, BMIC 306 can be configured to maintain a state of charge of battery 520 at half capacity, such as 50%, or some other level. Maintaining battery 520 at half capacity can preserver the battery life of battery 520. Voltage regulator 304 can include switching elements Q1, Q2, Q3, Q4 and an inductor L. Switching elements Q1, Q2, Q3, Q4 can be implemented by, for example, metal-oxide-semiconductor field-effect transistors (MOSFETs) or insulated-gate bipolar transistors (IGBTs). Switching elements Q1, Q2, Q3, Q4 can be arranged in a full-bridge configuration, with Q1, Q3 being high-side switches (e.g., connected between input and output) and Q2, Q4 being low-side switches (e.g., connected between output and ground). When controller 310 controls voltage regulator in the forward direction to charge battery 520 in battery module 302, controller 310 can switch Q1, Q2, Q3, Q4 in a specific pattern to direct changes from bus bar 101 to battery 520. When controller 310 controls voltage regulator in the reverse direction to discharge battery 520 in battery module 302, controller 310 can switch Q1, Q2, Q3, Q4 in another specific pattern to direct changes from battery 520 to bus bar 101.

Controller 310 can include at least amplifiers 502, 504, 506 and a RC circuit 508. Controller 310 can receive load signal 106 from power shelf 102. Load signal 106 can be received at an inverting input of amplifier 502, and at an non-inverting input of amplifier 502 through RC circuit 508. RC circuit 508 can be formed by a resistor R and a capacitor C connected in parallel. The resistance of resistor R and the capacitance C can be variable or otherwise selected in any desirable manner. By way of example, resistor R can be implemented by a variable resistor or a network of resistors, and capacitor C can be implemented by a variable capacitor or a network of capacitors. In one embodiment, an output of amplifier 502 can be dependent on a constant RC set in RC circuit 508, where time constant RC can define a predetermined range 509 of slew rate changes that can be between +RC and −RC. The constant RC can be less than Vcc, where Vcc can be the maximum voltage level of DC power 104. By way of example, when the rate of change of load signal 106 is within the predetermined range 509, amplifier 502 can output zero voltage. When the rate of change of load signal 106 is outside of the predetermined range 509, amplifier 502 can output a nonzero voltage, which may be positive or negative depending on whether the rate of change is positive or negative. The constant RC can be stored in a storage device 511 of controller 310. In one embodiment, storage device 511 can include one or more registers, and the constant RC can be written in a register among the one or more registers.

The nonzero voltage being output by amplifier 502 can trigger either one of amplifiers 504, 506 to output a nonzero voltage. In one embodiment, when the nonzero voltage being output by amplifier 502 is positive, or between +RC and −Vcc, amplifier 504 can output a nonzero voltage that can be provided to voltage regulator 304 as a charge signal 510, and amplifier 506 can output zero voltage. Charge signal 510 can control voltage regulator 304 to charge battery 520 using battery power 130 from bus bar 101. When the nonzero voltage being output by amplifier 502 is negative, or between −Vcc and −RC, amplifier 506 can output a nonzero voltage that can be provided to voltage regulator 304 as a discharge signal 512, and amplifier 504 can output zero voltage. Discharge signal 512 can control voltage regulator 304 to discharge battery 520 to add battery power 130 to bus bar 101.

### Example Waveforms Using Power Regulator

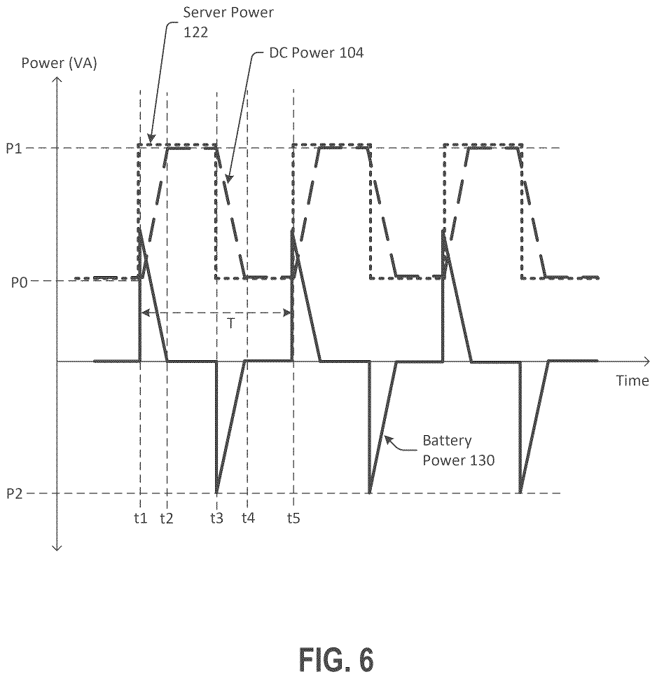

Referring to FIG. 6, example waveforms DC power 104, battery power 130 and server power 122 are shown. In the example shown in FIG. 6, DC power 104 can have power P0 initially, such as prior to time t1. At time t1, DC power 104 increases at a rate of change, or rate of increase, that is outside of the predetermined range 509. Hence, the output voltage of amplifier 502 can be a positive voltage, indicating a positive slew rate error, and amplifier 506 can output the discharge signal 512 to discharge battery 520. As shown in FIG. 6, battery power 130 is increased at time t1 and can be combined with DC power 104. The addition of battery 130 can gradually reduce to zero at time t2 as DC power 104 reaches the desired power P1. In one embodiment, controller 310 can be configured to determine the magnitude of battery power 130 in the duration from time t1 to time t2 based on load signal 106. By way of example, based on load signal 106, controller 310 can determine that it takes a duration of t2-t1 for DC power 104 to reach P1. Controller 310 can also determine the magnitudes of battery power 130 that are needed to be added to DC power 104 from t1 to t2 in order for DC power 104 to reach P1 at time t1 and to match the slew rate of the server load. Also, based on the determined duration t2-t1, controller 310 can determine that addition of battery power 130 to DC power 104 may no longer be needed, hence battery power 130 shall be zero at time t2. Based on the determined duration t2-t1, the determined magnitudes of battery power 130 between times t1 and t2, and the determination that battery power 130 is zero at t2, controller 310 can determine a slope corresponding to a decreasing slew rate of battery power 130 from t1 to t2. As a result of adding battery power 130 to DC power 104 between times t1 and t2, server power 122 can match the server load in the duration from t1 to t2. Further, controller 310 can control the magnitude of battery power 130 at time t1 to prevent power overshoot (see overshoot in FIG. 2).

Server power 122 can be maintained at P1 until time t3, where time t1 to t3 in FIG. 6 can be approximately half of cycle T. In one embodiment, DC power 104 can decrease at time t3 as a result of, for example, power shelf 102 using switching converters to regulate DC power 104 to have a constant target voltage level. When DC power 104 drops at time t3, load signal 106 provided by power shelf 102 can also decrease. In the example shown in FIG. 6, the rate of change, or rate of decrease, of load signal 106 at time t3 is outside of the predetermined range 509. Hence, the output voltage of amplifier 502 can be a negative voltage, indicating a negative slew rate error, and amplifier 506 can output the charge signal 510 to charge battery 520. As shown in FIG. 6, battery power 130 is decreased at time t3 to P2 such that at time t3, P2 is subtracted from DC power 104 to reduce server power 122 to P0. The subtraction of battery power 130 from DC power 104 can gradually stop, battery power 130 can return to zero at time t4, and server power 122 is maintained at P0 until a start of the next cycle, such as time t5. In one embodiment, controller 310 can also determine the magnitudes of battery power 130 that needs to be subtracted from DC power 104 from t3 to t4 in order for server power 122 to be maintain at P0 between time t3 to t4. Also, based on the duration t4-t3, controller 310 can determine that subtraction of battery power 130 from DC power 104 may no longer be needed at time t4 to pull down DC power 104, hence battery power 130 shall be zero at time t4. Based on the determined duration t4-t3, the determined magnitudes of battery power 130 at times t3 and t4, and the determination that battery power 130 is zero at t4, controller 310 can determine a slope corresponding to a increasing slew rate of battery power 130 from t3 to t4. Note that by pulling DC power 104 to drop server power 122 to P0 at t3, the duty cycle of server power 122 is 50%, hence server power 122 is being provided to server 110 at an acceptable efficiency, which in at least some cases is further considered to be an optimal efficiency. At the next cycle starting at time t5, the scheme to discharge and charge battery 520 can be repeated again.

Discharging and charging of one or more batteries in power regulator 120 described herein can provide an in-rack regenerative load technique to buffer and/or compensate the DC power being provided to servers that demand intensive computations. The server power being shaped and/or formed by combining the batteries' power with the DC power can be maintained within the operating envelopes of a power shelf that may include UPS and various types of generators. The shaping of the server power described herein can match the slew rate of the server power to the slew rate of the server load, reduce overshoot, and maintain optimal duty cycle of 50%. Also, the power regulator 120 described herein can be added to various types of existing server racks without modifications to the server racks themselves. Also, the power regulator 120 described herein can be operated in parallel with AC/DC power supplies.

### Example Method

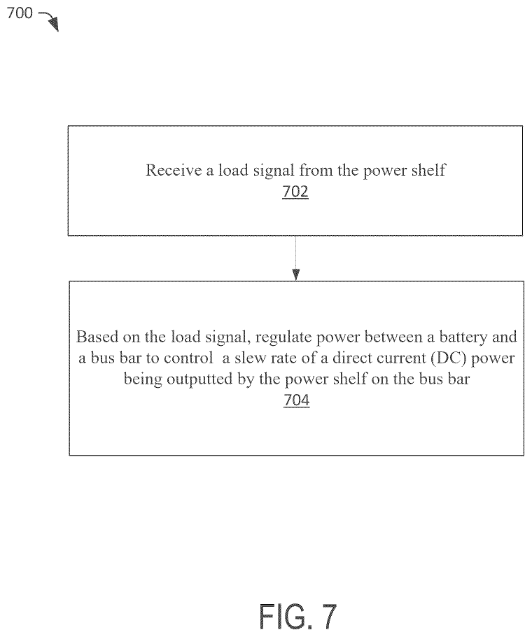

FIG. 7 illustrates an example method 700 of power slew rate control using energy storage device. The following acts may be rearranged, combined, and/or split without departing from the scope of this disclosure.

At 702, a power regulator can receive a load signal from a power shelf, where the load signal represents a load status of the power shelf. For example, power regulator 120 can receive load signal 106 from power shelf 102.

At 704, based on the load signal, the power regulator can regulate power between a battery and a bus bar to control a slew rate of a direct current (DC) power being outputted by the power shelf on the bus bar, where the bus bar can connect the server to the power shelf. For example, power regulator 120 can regulate DC power 104 based on load signal 106.

The power regulator can also regulate power between the battery and the bus bar by discharging the battery to add power from the battery to the DC power on the bus bar or charging the battery using power subtracted from the DC power on the bus bar. For example, power regulator 120 can discharge battery 520 in battery module 302 to add battery power 130 to DC power 104 or charge the battery 520 in battery module 302 by subtracting battery power 130 from DC power 104.

The power regulator can also determine a slew rate error based on the load signal, determine the slew rate error is associated with a step-up of the DC power, and in response to determining that the slew rate error is associated with the step-up of the DC power, discharge the battery 520 to add power to the DC power on the bus bar. For example, power regulator 120 can determine DC power 104 is increasing or stepping up, and discharge battery in battery module 302 to add battery power 130 to DC power 104.

The power regulator can also determine the slew rate error is associated with a step-down of the DC power, and in response to determining that the slew rate error is associated with the step-down of the DC power, charge the battery 520 using power subtracted from the DC power on the bus bar. For example, power regulator 120 can determine DC power 104 is decreasing or stepping down, and charge battery in battery module 302 using DC power 104 on bus bar 101.

The power regulator can also determine the slew rate error is within a range of predetermined values, and in response to determining that the slew rate error is within the range of predetermined values, maintain the slew rate of the DC power. For example, power regulator 120 can determine a change in DC power 104 is within the predetermined range 509, and can maintain the slew rate of DC power 104.

The power regulator can also maintain a state of charge of the battery at half capacity. For example, BMIC 306 in power regulator 120 can maintain battery 520 at 50% state of charge.

### EXAMPLES

Example 1: A device comprising: a battery; a voltage regulator; and a controller configured to: receive a load signal from a power shelf, wherein the load signal represents a load status of the power shelf; and based on the load signal, control the voltage regulator to regulate power between the battery and a bus bar connecting a server to the power shelf, wherein power regulation between the battery and the bus bar controls a slew rate of a direct current (DC) power being outputted from the power shelf on the bus bar.
Example 2: The device of Example 1, wherein in regulating the power between the battery and the bus bar, the controller is configured to: control the voltage regulator to discharge the battery to add power from the battery to the DC power on the bus bar; and control the voltage regulator to charge the battery using power subtracted from the DC power on the bus bar.
Example 3: The device of Example 1 or 2, wherein the controller is configured to: determine a slew rate error based on the load signal; determine the slew rate error is associated with a step-up of the DC power; and in response to determining that the slew rate error is associated with the step-up of the DC power, control the voltage regulator to discharge the battery to add power to the DC power on the bus bar.
Example 4: The device of any of Examples 1 to 3, wherein the controller is configured to: determine a slew rate error based on the load signal; determine the slew rate error is associated with a step-down of the DC power; and in response to determining that the slew rate error is associated with the step-down of the DC power, control the voltage regulator to charge the battery using power subtracted from the DC power on the bus bar.
Example 5: The device of any of Examples 1 to 4, wherein the controller is configured to: determine a slew rate error based on the load signal; determine the slew rate error is within a range of predetermined values; and in response to determination that the slew rate error is within the range of predetermined values, maintain the slew rate of the DC power on the bus bar.
Example 6: The device of any of Examples 1 to 5, wherein the voltage regulator includes a bi-directional buck-boost voltage regulator.
Example 7: The device of any of Examples 1 to 6, further includes a battery management integrated circuit configured to maintain a state of charge of the battery at half capacity.
Example 8: A system comprising: a server; a bus bar; a power shelf configured to provide a direct current (DC) power to the server via the bus bar; and a power regulator configured to: receive a load signal from the power shelf, wherein the load signal represents a load status of the power shelf; and based on the load signal, regulate power between a battery and the bus bar to control a slew rate of the DC power provided by the power shelf on the bus bar.
Example 9: The system of Example 8, wherein in regulating the power between the battery and the bus bar, the power regulator is configured to: discharge the battery to add power from the battery to the DC power on the bus bar; and charge the battery using power subtracted from the DC power on the bus bar.
Example 10: The system of any of Example 8 or 9, wherein the power regulator is configured to: determine a slew rate error based on the load signal; determine the slew rate error is associated with a step-up of the DC power; and in response to determination that the slew rate error is associated with the step-up of the DC power, discharge the battery to add power to the DC power on the bus bar.
Example 11: The system of any of Examples 8 to 10, wherein the power regulator is configured to: determine a slew rate error based on the load signal; determine the slew rate error is associated with a step-down of the DC power; and in response to determination that the slew rate error is associated with the step-down of the DC power, charge the battery using power subtracted from the DC power on the bus bar.
Example 12: The system of any of Examples 8 to 11, wherein the power regulator is configured to: determine a slew rate error based on the load signal; determine the slew rate error is within a range of predetermined values; and in response to determination that the slew rate error is within the range of predetermined values, maintain the slew rate of the DC power.
Example 13: The system of any of Examples 8 to 12, wherein the power regulator is configured to operate a bi-directional buck-boost voltage regulator to regulate power between the battery and the bus bar.
Example 14: The system of any of Examples 8 to 13, wherein the power regulator is configured to maintain a state of charge of the battery at half capacity.
Example 15: A method of regulating power between a power shelf and a server, the method comprising: receiving a load signal from the power shelf, wherein the load signal represents a load status of the power shelf; and based on the load signal, regulating power between a battery and a bus bar to control a slew rate of a direct current (DC) power being outputted by the power shelf on the bus bar, wherein the bus bar connects the server to the power shelf.
Example 16: The method of Example 15, wherein regulating power between the battery and the bus bar includes one of: discharging the battery to add power from the battery to the DC power on the bus bar; and charging the battery using power subtracted from the DC power on the bus bar.
Example 17: The method of Examples 15 or 16, further includes: determining a slew rate error based on the load signal; determining the slew rate error is associated with a step-up of the DC power; and in response to determining that the slew rate error is associated with the step-up of the DC power, discharging the battery to add power to the DC power on the bus bar.
Example 18: The method of any of Examples 15 to 17, further includes: determining a slew rate error based on the load signal; determining the slew rate error is associated with a step-down of the DC power; and in response to determining that the slew rate error is associated with the step-down of the DC power, charging the battery using power subtracted from the DC power on the bus bar.
Example 19: The method of any of Examples 15 to 18, further includes: determining a slew rate error based on the load signal; determining the slew rate error is within a range of predetermined values; and in response to determining that the slew rate error is within the range of predetermined values, maintaining the slew rate of the DC power.
Example 20: The method of any of Examples 15 to 19, further includes maintaining a state of charge of the battery at half capacity.

### Terminology

Server, as used herein, may refer to any computer or computing device that receives and/or provides information to clients on a computer network (e.g., wired, fiberoptic, wireless, or some combination thereof). The server may be an application server, a catalog server, a communications server, a computing server, a database server, a storage server, a machine learning server, a predictive analysis server, a fax server, a file server, a game server, a mail server, a media server, a print server, a sound server, a proxy server, a virtual server, a web server, some combination thereof, or a sever serving a different purpose or having a different type of architecture.

The server may include at least one processing unit configured to execute various operations of the server. The processing unit may include one or more processors, one or more central processing units (CPUs), one or more graphics processing units (GPUs), one or more application-specific integrated circuits (ASICs), one or more controllers or microcontrollers, one or more ladder logic controllers, one or more other types of control logic, conventional control systems (e.g., relays, switches, delays) or some combination thereof.

To cool the server, the server may include a cooling system. For example, the server may include a liquid cooling system configured to draw heat from the processing unit. The heat gathered from the processing unit can then be drawn away from the server (e.g., to an outside of a room or building). The cooling system may also, alternatively or additionally, include one or more fans configured to cool components of the server and/or work in conjunction with, or instead of, the liquid cooling system.

When implemented as a liquid cooling system, the cooling system may include one or more drip trays configured to capture leaking coolant from inside the server. The drip trays may be cascading (e.g., an effluent from one becomes an influent for another) and may contain one or more sensors configured to detect whether liquid is within the drip trays.

The liquid cooling system may also contain one or more fluid connections. The fluid connections may include quick-disconnect fittings attached to an external surface of the server. The quick disconnect fittings may be coupled to a heat exchanger within the server (e.g., proximate the processing unit). The fluid connections may be configured to attach to a cooling system or a manifold attached to other servers (e.g., within a same rack, within an adjacent rack, or in some other configuration).

The server may be a standard width (e.g., 19 inches or 21 inches) or a custom dimension. The server may also have any suitable depth. For example, the server may be arranged to not exceed approximately one meter in depth.

The server may contain computer-readable storage memory or media (CRM). The CRM may contain random access memory (RAM), electrically erasable programmable read-only memory (EEPROM), flash memory, one or more disk drives, or some combination thereof. The CRM may contain instructions that cause the processing unit to perform various functions of the server. The CRM may be software, firmware, or some combination thereof. The CRM may also include and/or hold data for the server to use for various functionalities.

The server may also include a power supply configured to supply power to various components within the server. The power supply may be configured to adapt or change incoming power (e.g., alternating current to direct current and/or stepping up or stepping down voltage). Furthermore, the power supply may be configured to supply different power to different components of the server.

The server may include one or more sensors configured to facilitate various functionalities of the server. For example, the sensors may include temperature, humidity, sound, tamper, vibration/shock, and/or moisture sensors. The sensors may also be disposed on an exterior of the server (e.g., on a rack or in a facility proximate the server).

The server may also include one or more clocks. The clocks may enable various functionality of the server to be timed and/or synchronized with another server or computing device.

The server may also include or otherwise be functional to implement one or more alarms. The alarms may be based on any of the sensors above and/or any other logic or instructions executing within the server. For example, the server may be able to notify a surrounding environment (e.g., via an audible tone) or another server or computing device (e.g., a server monitoring system) that a leak has occurred or that the server is overheating.

The server may be a stand-alone unit or may be attached to a server rack. The server rack (or simply, rack), may hold any number of servers. Outside of the rack, the server may include a Level 10 assembly. When installed in the rack with one or more other servers, the server may become part of a Level 11 assembly (e.g., rack-level or multi-rack level).

The server may be installed and/or removed from the rack via any means. For example, guide rails may be used to slide the server into and out of the server rack while latches and/or fasteners may be used to secure the server to the server rack.

The rack may contain a centralized heat transfer system configured to draw heat from the servers disposed therein. The heat transfer system may include one or more manifolds directing/gathering liquid coolant to/from the servers. The heat transfer system may also include a side car unit or attach to a facility heat transfer system.

As part of the heat transfer system, the rack may contain one or more drip trays and/or associated systems. For example, the drip trays may contain a set of cascading drip trays and may have one or more alarms based on liquid being within one or more of the trays.

### CONCLUSION

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, the terms up, upper, down, lower, above, below, left, right, forward, rearward, and the like are intended to be understood in the context of the representations described and illustrated above so that a wearable device may have such an orientation in reference to the frame or to various elements as supported by the frame or as illustrated in the drawing figures.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description but is not intended to be exhaustive or limited to this disclosure in the form disclosed. Many modifications and variations will be apparent to those of ordinary skill in the art without departing from the scope and spirit of this disclosure. The various embodiments were chosen and described in order to best explain the principles of this disclosure and the practical application, and to enable others of ordinary skill in the art to understand this disclosure for various embodiments with various modifications as are suited to the particular use contemplated.

1. A device comprising:
a battery;
a voltage regulator; and
a controller configured to:
receive a load signal from a power shelf, wherein the load signal represents a load status of the power shelf;
determine, based on the load signal, an error of a slew rate of a direct current (DC) power being outputted from the power shelf on a bus bar connecting a server to the power shelf;
determine whether the error is within a range of predetermined slew rate values or outside of the range of predetermined slew rate values;
when the error is within the range of predetermined slew rate values, maintain the slew rate of the DC power on the bus bar; and
when the error is outside of the range of predetermined slew rate values, control the voltage regulator to regulate power between the battery and the bus, wherein power regulation between the battery and the bus bar controls the slew rate of the DC power.

2. The device of claim 1, wherein to regulate the power between the battery and the bus bar, the controller is configured to:
control the voltage regulator to discharge the battery to add power from the battery to the DC power on the bus bar; and
control the voltage regulator to charge the battery using power subtracted from the DC power on the bus bar.

3. The device of claim 1, wherein the controller is configured to:
determine the error is associated with a step-up of the DC power; and
in response to determining that the error is associated with the step-up of the DC power, control the voltage regulator to discharge the battery to add power to the DC power on the bus bar.

4. The device of claim 1, wherein the controller is configured to:
determine the error is associated with a step-down of the DC power; and
in response to determining that the error is associated with the step-down of the DC power, control the voltage regulator to charge the battery using power subtracted from the DC power on the bus bar.

5. (canceled)

6. The device of claim 1, wherein the voltage regulator includes a bi-directional buck-boost voltage regulator.

7. The device of claim 1, further includes a battery management integrated circuit configured to maintain a state of charge of the battery at half capacity.

8. A system comprising:
a server;
a bus bar;
a power shelf configured to provide a direct current (DC) power to the server via the bus bar; and
a power regulator configured to:
receive a load signal from the power shelf, wherein the load signal represents a load status of the power shelf;
determine, based on the load signal, an error of a slew rate of a direct current (DC) power being outputted from the power shelf on the bus bar;
determine whether the error is within a range of predetermined slew rate values or outside of the range of predetermined slew rate values;
when the error is within the range of predetermined slew rate values, maintain the slew rate of the DC power on the bus bar; and
when the error is outside of the range of predetermined slew rate values, regulate power between a battery and the bus bar to control a slew rate of the DC power provided by the power shelf on the bus bar.

9. The system of claim 8, wherein to regulate the power between the battery and the bus bar, the power regulator is configured to:
discharge the battery to add power from the battery to the DC power on the bus bar; and
charge the battery using power subtracted from the DC power on the bus bar.

10. The system of claim 8, wherein the power regulator is configured to:
determine the error is associated with a step-up of the DC power; and
in response to determination that the error is associated with the step-up of the DC power, discharge the battery to add power to the DC power on the bus bar.

11. The system of claim 8, wherein the power regulator is configured to:
determine the error is associated with a step-down of the DC power; and
in response to determination that the error is associated with the step-down of the DC power, charge the battery using power subtracted from the DC power on the bus bar.

12. (canceled)

13. The system of claim 8, wherein the power regulator is configured to operate a bi-directional buck-boost voltage regulator to regulate power between the battery and the bus bar.

14. The system of claim 8, wherein the power regulator is configured to maintain a state of charge of the battery at half capacity.

15. A method of regulating power between a power shelf and a server, the method comprising:
receiving a load signal from the power shelf, wherein the load signal represents a load status of the power shelf;
determining, based on the load signal, an error of a slew rate of a direct current (DC) power being outputted from the power shelf on a bus bar connecting a server to the power shelf;
determining whether the error is within a range of predetermined slew rate values or outside of the range of predetermined slew rate values;
when the error is within the range of predetermined slew rate values, maintaining the slew rate of the DC power on the bus bar; and
when the error is outside of the range of predetermined slew rate values, regulating power between a battery and the bus bar to control a slew rate of a direct current (DC) power being outputted by the power shelf on the bus bar.

16. The method of claim 15, wherein regulating power between the battery and the bus bar includes:
discharging the battery to add power from the battery to the DC power on the bus bar; and
charging the battery using power subtracted from the DC power on the bus bar.

17. The method of claim 15, further includes:
determining the error is associated with a step-up of the DC power; and
in response to determining that the error is associated with the step-up of the DC power, discharging the battery to add power to the DC power on the bus bar.

18. The method of claim 15, further includes:
determining the error is associated with a step-down of the DC power; and
in response to determining that the error is associated with the step-down of the DC power, charging the battery using power subtracted from the DC power on the bus bar.

19. (canceled)

20. The method of claim 15, further includes maintaining a state of charge of the battery at half capacity.

21. The device of claim 1, wherein the range of predetermined slew rate values is adjustable.

22. The device of claim 1, wherein the controller comprises:
a resistor-capacitor (RC) circuit configured to set the range of predetermined slew rate values; and
an error amplifier configured to compare the error with the range of predetermined slew rate values.

23. The device of claim 1, wherein the battery and voltage regulator are parts of a power regulator unit among a plurality of power regulator units in the device.
